(19) United States
(12) Patent Application Publication
(10) Pub. No.: US 2026/0329800 A1
(43) Pub. Date: Oct. 22, 2026

(54) PLATFORM LEVEL DATA MODELING OVER DATA OBJECT EXCHANGE

(71) Applicant: Micron Technology, Inc., Boise, ID (US)

(72) Inventor: Rohit K. SINDHU, Los Gatos, CA (US)

(21) Appl. No.: 19/548,126

(22) Filed: Feb. 24, 2026

Related U.S. Application Data
(60) Provisional application No. 63/792,633, filed on Apr. 22, 2025.

(51) Int. Cl. G06F 13/42; G06F 9/448

(52) U.S. Cl. CPC G06F 13/4221; G06F 9/4488; G06F 2213/0026

(57) ABSTRACT

In some implementations, a host device may transmit a request data object exchange (DOE) data object via a peripheral component interconnect express (PCIe) DOE instance, and the request DOE data object may comprise a first plurality of data words that encapsulate a request for platform level data modeling (PLDM) information associated with a device. The host device may receive, from the device and via the PCIe DOE instance, a response DOE data object comprising a second plurality of data words that encapsulate the PLDM information based at least in part on the request DOE data object. In some aspects, the host device may receive, from the device and via the PCIe DOE instance, an asynchronous DOE data object encapsulating additional PLDM information.

### CROSS-REFERENCE TO RELATED APPLICATION

This Patent Application claims priority to U.S. Provisional Patent Application No. 63/792,633, filed on Apr. 22, 2025, entitled “PLATFORM LEVEL DATA MODELING OVER DATA OBJECT EXCHANGE,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to platform level data modeling over data object exchange.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., not AND (NAND) memory and not OR (NOR) memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL) protocol and/or a CXL compliant memory system.

The peripheral component interconnect (PCI) protocol is a protocol for input/output (I/O) communication via a PCI bus, which may be implemented on a motherboard of a computer. The PCI bus supports the functions found on a processor bus, but in a standardized format that is independent of any particular processor's native bus. The PCI protocol has evolved into the PCI express (PCIe) protocol, which provides benefits such as a higher throughput, reduced pin count, and better performance scaling in comparison to legacy PCI.

### BRIEF DESCRIPTION OF THE DRAWINGS

FIG. 1 is a diagram illustrating an example system capable of supporting platform level data modeling (PLDM) messages over data object exchange (DOE) data objects.

FIG. 2 is a diagram illustrating another example system capable of supporting PLDM messages over DOE data objects.

FIG. 3 is a diagram illustrating an example of a PLDM message encapsulated in a DOE data object.

FIG. 4 is a diagram of an example of communicating PLDM request messages encapsulated in DOE data objects.

FIG. 5 is a diagram of an example of communicating PLDM response messages or asynchronous PLDM messages encapsulated in DOE data objects.

FIGS. 6, 7, and 8 are flowcharts of example methods associated with PLDM over DOE.

### DETAILED DESCRIPTION

Some memory systems may use platform level data modeling (PLDM) messages to exchange device management information, such as firmware updates, health monitoring, error reporting, configuration settings, or other management information. PLDM provides a standardized way for devices to communicate these management functions, aiding in interoperability between different devices and systems, such as between a host system and a memory system. In some systems, PLDM messages are sent over in-band peripheral component interconnect express (PCIe) using a management component transport protocol (MCTP). This approach requires an intermediate PCI device capable of generating PLDM MCTP packets, which may often use specialized hardware such as PCIe interposer cards and PCIe exerciser units. These intermediate devices may act as translators, converting the PLDM messages into a format that can be transmitted over the PCIe bus and then reassembling the PLDM messages at the receiving end.

In some cases, however, the specialized hardware components used to generate PLDM messages may be costly or may require significant development efforts to support different systems. Additionally, or alternatively, the reliance on such specialized hardware may introduce latency or additional potential points of failure in the communication process, further complicating the exchange of device management information between a memory system and a host system. Accordingly, supporting device management operations such as troubleshooting, error reporting, or configuration updates may be associated with increased system costs due to the specialized hardware.

Some implementations described herein enable the transmission of PLDM messages using data object exchange (DOE) data objects. DOE data objects may allow the exchange of PLDM information without the use of specialized hardware to generate MCTP messages. In some aspects, one or more data object types may be defined for transmission of PLDM messages. For example, a first data object type may be used for sending request DOE messages that include a request of PLDM information, or for sending response DOE messages based on a received request DOE message. In some aspects, a second data object type may be defined for asynchronous DOE messages, which may be used by a memory system to send asynchronous PLDM information (e.g., error or exception indications). As DOE data objects may be generated using software, the described techniques may simplify the communication process between a host system and a memory system. Additionally, or alternatively, the sending of PLDM messages over DOE data objects may allow proprietary or legacy platforms that do not support MCTP transport to support PLDM messages. Accordingly, by leveraging DOE signaling for the exchange of PLDM information, the described implementations may streamline the communication process, reduce costs, and enhance compatibility across a wide range of computing platforms.

By enabling the transmission of PLDM messages using DOE data objects, the described techniques may eliminate the requirement for specialized hardware to generate PLDM messages over MCTP. This reduction in hardware components not only lowers the overall system complexity and cost, but also contributes to a decrease in material usage and electronic waste. Simplifying the communication process with software-generated DOE data objects enhances the energy efficiency of the system, as fewer resources are required for development, deployment, and maintenance. This approach may support the creation of more sustainable information technology infrastructure by minimizing the environmental impact associated with manufacturing and disposing of additional hardware components. Consequently, the described techniques may promote the development of energy-efficient technologies that align with the growing demand for sustainability practices in the information technology industry, ultimately contributing to the reduction of the carbon footprint and the conservation of natural resources.

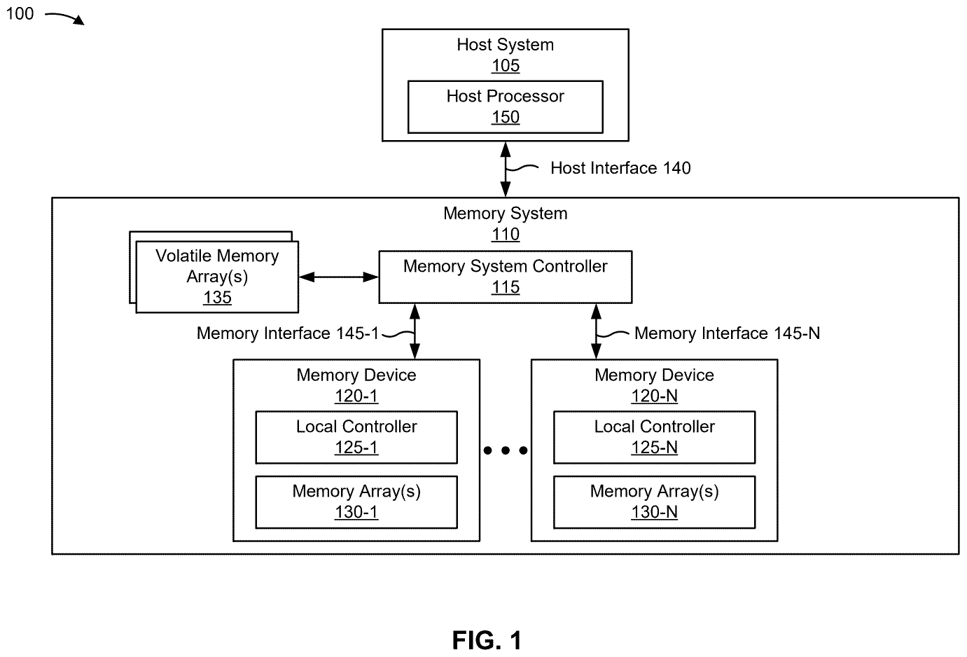

FIG. 1 is a diagram illustrating an example system 100 capable of supporting PLDM messages over DOE data objects. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a CPU, a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

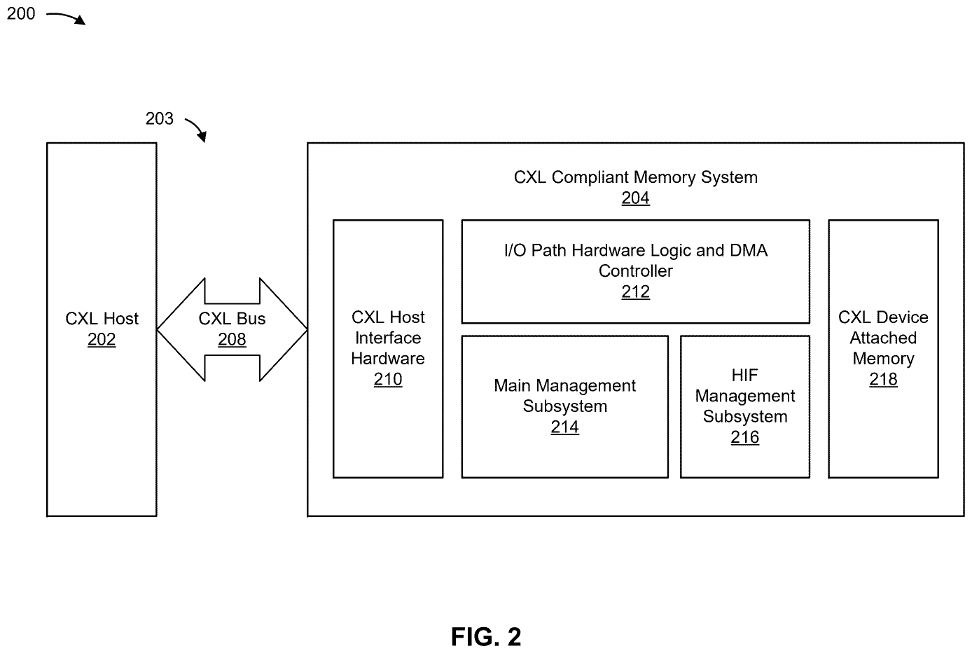

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive a first plurality of data words of a request DOE data object that encapsulates a request for PLDM information; and transmit a second plurality of data words of a response DOE data object that encapsulates the PLDM information based on the request DOE data object.

In some implementations, one or more systems, devices, apparatuses, components, and/or controllers of FIG. 1 may be configured to set a data object ready bit of a DOE status register to a first value; and write, to a DOE read register after the data object ready bit is set to the first value, a first plurality of data words of an asynchronous DOE data object that encapsulates PLDM information associated with the device.

In some implementations, one or more systems, devices, apparatuses, components, and/or controllers of FIG. 1 may be configured transmit, over a DOE instance associated with PLDM messages, a first plurality of data words of a request DOE data object that encapsulates a request for PLDM information; and transmit, over the DOE instance, a second plurality of data words of a response DOE data object based at least in part on the request DOE data object, wherein the response DOE data object encapsulates the PLDM information.

In some implementations, one or more systems, devices, apparatuses, components, and/or controllers of FIG. 1 may be configured to transmit a request DOE data object via a PCIe DOE instance, wherein the request DOE data object comprises a first plurality of data words that encapsulate a request for PLDM information associated with a device; and receive, via the PCIe DOE instance, a response DOE data object comprising a second plurality of data words that encapsulate the PLDM information based at least in part on the request DOE data object.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 capable of supporting PLDM messages over DOE data objects. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL. io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL. cache protocol, which may be used for purposes such as caching host memory using a modified, exclusive, shared, invalid (MESI) coherence protocol, or similar purposes); or a memory protocol layer (e.g., a layer associated with a CXL. memory (sometimes referred to as CXL. mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL. cache protocol. A CXL type 2 device may be a device that implements both a coherent cache using the CXL. cache protocol and a host-managed device memory using the CXL. mem protocol. For example, a CXL type 2 device may be a hardware accelerator device. A CXL type 3 device may be a device that implements a host-managed device memory using the CXL. mem protocol. For example, a CXL type 3 device may be a memory expander device.

In some aspects, the system 200 may support transmission of PLDM messages using DOE data objects. DOE data objects may allow the exchange of PLDM information without the use of specialized hardware to generate MCTP messages. In some aspects, one or more data object types may be defined for transmission of PLDM messages. For example, a first data object type may be used for sending request DOE messages that include a request of PLDM information, or for sending response DOE messages based on a received request DOE message. In some aspects, a second data object type may be defined for asynchronous DOE messages, which may be used by a memory system to send asynchronous PLDM information (e.g., error or exception indications). As DOE data objects may be generated using software, the described techniques may simplify the communication process between a host system and a memory system. Additionally, or alternatively, the sending of PLDM messages over DOE data objects may allow proprietary or legacy platforms that do not support MCTP transport to support PLDM messages.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

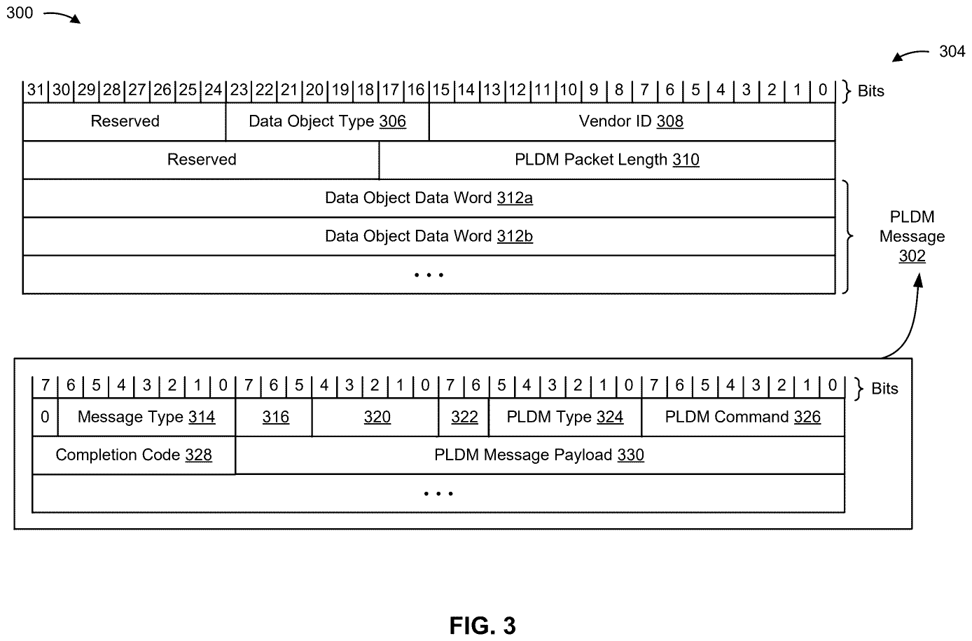

FIG. 3 is a diagram illustrating an example 300 of a PLDM message 302 (e.g., a PLDM packet) encapsulated in a DOE data object 304. As shown, the DOE data object 304 may include a data object type field 306, a vendor identifier (ID) field 308, a PLDM packet length field 310, and one or more data object data words 312.

The data object type field 306 and/or the vendor ID field 308 may include values indicating that the DOE data object 304 encapsulates the PLDM message 302 (e.g., indicating that the DOE data object 304 is being used for PLDM message communication). In some examples, a vendor ID and/or one or more data object types (e.g., a vendor-defined data object type) may be used to identify DOE data objects that carry PLDM messages 302. In some aspects, the data object type field 306 may indicate a first data object type used for synchronous PLDM messages 302. For example, the first data object type may be used for PLDM request messages, which may include a command requesting PLDM information or an operation to be performed by a device, and PLDM response messages, which may include the PLDM information or an indication associated with completion of the requested operation to be performed by the device. In some examples, the first data object type (e.g., for MCTP requests and responses) may be used for PLDM messages 302 over DOE when the first data object type is supported by a specific DOE instance on a device. In some examples, DOE data objects of the first data object type may include DOE discovery response data object contents.

As another example, the data object type field 306 may indicate a second data object type used for asynchronous PLDM messages 302. For example, the second data object type may be used for asynchronous PLDM messages 302 sent from a device to a host device. In some aspects, asynchronous PLDM messages 302 may be sent from the device to the host device without prior solicitations. For example, the second data object type may be used for PLDM messages 302 generated asynchronously by a device on a specific DOE instance, and asynchronous PLDM messages 302 may indicate, for example, PLDM information such as one or more errors, exceptions, or other conditions detected by the device. In some examples, DOE data objects of the second data object type may be required to include DOE discovery response data object contents.

The PLDM message 302 may include data object data words 312 (also referred to as DWORDs), which may encapsulate the PLDM message 302. For example, a host device may generate a request DOE data object including a request for PLDM information from the device. Additionally, or alternatively, the device may send, to the host device, a response DOE data object including a PLDM message 302 that may include information requested by the host device. In these examples, data object type fields 306 of the DOE data objects 304 may indicate the first data object type used for synchronous PLDM messages 302. DOE data objects 304 may be exchanged between the host device and the device using PCIe configuration read and write messages. In this way, PCI DOE mailbox writes and reads between the host device (e.g., executing software) and the device (e.g., executing firmware) can be used for PLDM messages 302 requests and responses. In some implementations, a maximum DOE data object size may be 256 kilobyte data words, which may correspond to a maximum PLDM message size minus two data words for the data object header. In some aspects, a size of the DOE data object 304 may be dictated by a size of the underlying PLDM message 302.

In some aspects, the device may transmit an asynchronous message to the host device using an asynchronous DOE message that identifies (e.g., using the data object type field 306) the vendor-defined DOE data object type used for asynchronous PLDM messages 302. For example, asynchronous PLDM messages 302 (e.g., interrupts, error indications, or other messages) may use the message signaled interrupts extended (MSI-X) mechanism defined in the DOE protocol. The use of MSI-X may be indicated via a DOE interrupt support bit in a DOE capabilities register. In some implementations, a DOE interrupt enable bit may be indicated as enabled (e.g., set to “1”) by default in order to support MCTP interrupts in DOE interrupts.

In some aspects, the PLDM message 302 may include a message type field 314, which may indicate the message is a PLDM message 302. The PLDM message 302 may additionally include bits 316. In some examples, the bits 316 may include one or more request bits (e.g., an Rq bit), which may indicate whether the PLDM message 302 is a request message (e.g., sent from the host device to the device). Additionally, or alternatively, the bits 316 may include one or more datagram bits (e.g., a D bit), which may indicate whether an instance ID field 320 is used for tracking and matching requests and responses (e.g., to match PLDM requests to PLDM responses) or used for asynchronous PLDM messages 302 (or left unused, such as for asynchronous PLDM messages). For example, the instance ID field 320 may be used to identify a new instance of a PLDM request, or to match up an instance of a PLDM response to a corresponding instance of a PLDM request (e.g., by indicating the corresponding instance ID).

In some examples, the PLDM message 302 may include a header version field 322, which may be used to indicate a header format (e.g., a format version for a PLDM message header). Additionally, or alternatively, the PLDM message 302 may include a PLDM type field 324. The PLDM type field 324 may indicate a type of PLDM that is being used in a control or data transfer carried out using the PLDM message 302. For example, the PLDM type field 324 may be used to group PLDM messages 302 based on corresponding functions. In some examples, the PLDM message 302 may include a PLDM command field 326. The PLDM command field 326 may indicate a type of operation that is being requested by a PLDM request message. In some examples, a PLDM response message corresponding to a PLDM request message may use the same PLDM command field 326 as the corresponding PLDM request message.

In some examples, the PLDM message 302 may include a completion code field 328. The completion code field 328 may indicate a status of an operation. For example, the completion code field 328 may indicate whether a command requested by a PLDM request message completed successfully (e.g., normally). Additionally, or alternatively, in cases where the command did not complete successfully, the completion code field 328 may indicate additional information, such as an indication of one or more error conditions. In some cases, the PLDM completion code field 328 may be used for PLDM response messages, and bits used for the completion code field 328 may instead be used for a PLDM message payload 330 in PLDM request messages.

The PLDM message 302 may include the PLDM message payload 330, which may include zero or more bytes specific to a particular PLDM message 302. In some examples, the PLDM message payload 330 may follow a format from a set of formats, and a first byte of the PLDM message payload 330 may indicate the format. In some aspects, the PLDM message payload 330 may extend for multiple data words, which may correspond to multiple data object data words 312. As shown in FIG. 3, the message type field 314, the bits 316, the instance ID field 320, the header version field 322, the PLDM type field 324, and the PLDM command field 326 may be included in a first data object data word 312a. Additionally, the completion code field 328 (if included, such as for PLDM response messages) and at least a portion of the PLDM message payload 330 (if included) may be included in a second data object data word 312b. In some aspects, one or more additional data object data words 312 may be used to encapsulate additional data words of the PLDM message payload 330 (if present).

As indicated above, FIG. 3 is provided as an example. Other examples may differ from what is described with regard to FIG. 3. For example, the DOE data object 304 or the PLDM message 302 may use different formats than as shown in FIG. 3.

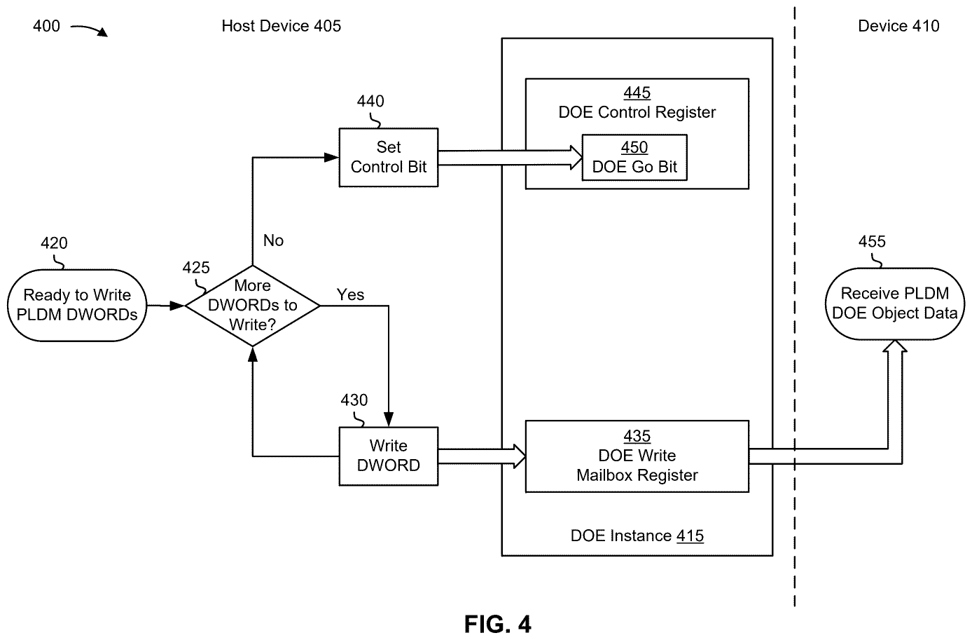

FIG. 4 is a diagram of an example 400 of communicating PLDM request messages encapsulated in DOE data objects. Example 400 includes a host device 405 and a device 410, which may be examples of corresponding devices as described herein. The host device 405 may correspond to or may include host processor 150. The device 410 may be a PCIe device or a CXL device. For example, the device 410 may correspond to or may include memory system 110 or a device of memory system 110 (e.g., memory system controller 115 and/or a local controller 125). In some implementations, the device 410 may be another type of PCIe or CXL compliant device, such as a graphics card, a network interface card, a sound card, or the like. The host device 405 and the device 410 may be connected via a PCIe link (e.g., a physical PCIe connector).

In some examples, the host device 405 may implement a DOE instance 415 to facilitate the communication of DOE data objects between the host device 405 and the device 410. For example, the DOE instance 415 may enable communication between software of the host device 405 and firmware of the device 410. In some examples, the DOE instance 415 may include one or more registers (e.g., memory-mapped registers). In some aspects, the DOE instance 415 may be a dedicated DOE instance for PLDM messages, which may avoid conflicts with other message protocols. In some cases, the use of a connection identifier for PLDM message features may not be required due to the use of the dedicated ODE instance.

As shown in FIG. 4, the host device 405 may generate data words for a PLDM request message to be sent via a DOE data object (e.g., a request DOE data object). For example, at block 420, the host device 405 (e.g., software executing on the host device 405) may be ready to write data words that may represent a request DOE data object encapsulating a PLDM request message to the DOE instance 415. At block 425, when the host device 405 has at least one remaining data word to transmit, the host device 405 may write a data word (shown as “DWORD”) to a DOE write mailbox register 435 of the DOE instance 415, as shown by block 430. In some examples, the writing may cause a configuration write message PCIe transaction layer packet (TLP) containing the data word to be sent to the device 410 (e.g., via the DOE instance 415). The host device 405 may perform the operation of block 430 one or more times until all data words of the request DOE data object have been sent to the device 410. When the host device 405 has no more remaining data words to transmit, the host device 405 may set a control bit of a DOE control register 445 of the DOE instance 415, as shown by block 440. For example, the host device 405 may set a DOE go bit 450 in the DOE control register 445 to a first value that may indicate a completion of the transmission of the request DOE data object.

As further shown by block 455, the device 410 may receive the data words (e.g., in respective configuration write message TLPs) as the data words are written to the DOE write mailbox register 435 (e.g., one at a time). For example, the device 410 may consume the request DOE data object as configuration write message TLPs arrive at the device 410 (e.g., the DOE instance 415 may consume the request DOE data object from the DOE write mailbox register 435). In some examples, the device 410 may stop receiving PLDM data from the DOE instance 415 in accordance with the setting of the DOE go bit 450.

As indicated above, FIG. 4 is provided as an example. Other examples may differ from what is described with regard to FIG. 4.

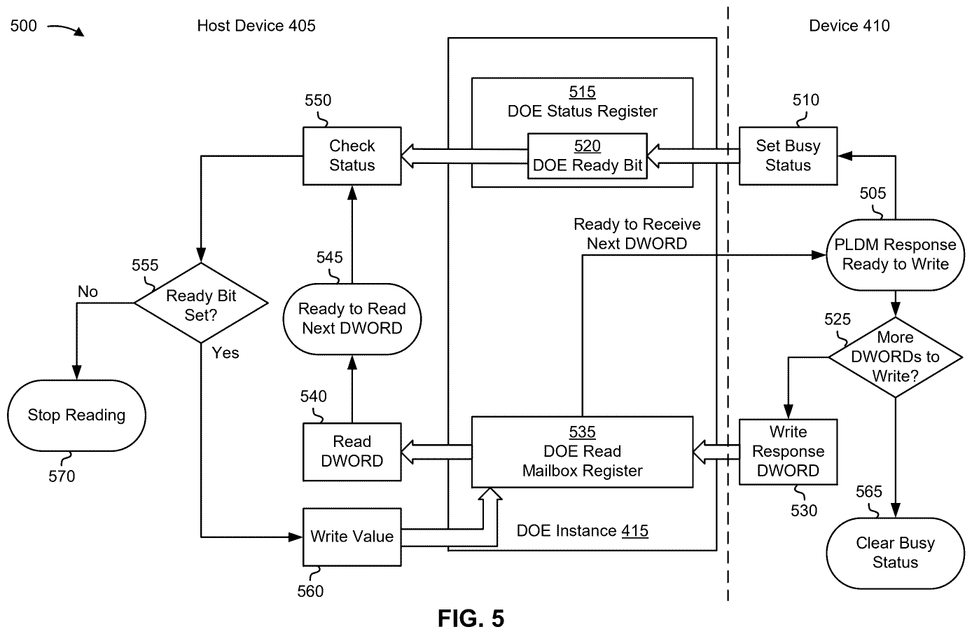

FIG. 5 is a diagram of an example 500 of communicating PLDM response messages or asynchronous PLDM messages encapsulated in DOE data objects. Example 500 includes the host device 405, the device 410, and the DOE instance 415 described in connection with FIG. 4.

As shown in FIG. 5, the device 410 may generate data words for a PLDM response message via a DOE data object (e.g., a response DOE data object), which may be responsive to or otherwise based on a PLDM request message received from the host device 405, as described herein. Additionally, or alternatively, the data words may be for an asynchronous PLDM message, which does not correspond to a PLDM request message received from the host device 405.

For example, at block 505 the device 410 (e.g., firmware executing on the device 410) may be ready to write data words that may represent a response DOE data object encapsulating a PLDM response message to the DOE instance 415. At block 510, based on having one or more data words to write to the DOE instance 415, the device 410 may set a busy status for the DOE instance 415 via a DOE status register 515 of the DOE instance 415. For example, the device 410 may set a DOE ready bit 520 in the DOE status register 515 to a first value to indicate that the device 410 has data words to write. At block 525, when the device 410 has at least one remaining data word to transmit, the device 410 may write a data word (shown as “DWORD”) corresponding to the response DOE data object to the DOE instance 415, as shown by block 530. For example, the device 410 may cause the data word to be written to a DOE read mailbox register 535 of the DOE instance 415. In some examples, to write the data word, the device 410 may transmit (e.g., via the DOE instance 415) a configuration write message TLP, containing the data word, that causes the data word to be written to the DOE read mailbox register 535.

As further shown by block 540, the host device 405 may read the data word from the DOE read mailbox register 535. At block 545, when the host device 405 is ready to continue reading data words (e.g., when software executing on the host device 405 is ready to read data words from the DOE instance 415), the host device 405 may check a status associated with the DOE instance 415, as shown by block 550. For example, the host device 405 may read the DOE ready bit 520 in the DOE status register 515. At block 555, when the DOE ready bit 520 is set (e.g., to the first value) indicating that the device 410 has additional data words to write, the host device 405 may write a value (e.g., any value) to the DOE read mailbox register 535 to indicate that the next data word can be written to the DOE read mailbox register 535, as shown by block 560. The device 410 may receive the value indicating that the next data word can be written to the DOE read mailbox register 535 (e.g., as a configuration write message TLP, via the DOE instance 415).

The device 410 may perform the operation of block 530, and the host device 405 may perform the operations of blocks 540 through 560, one or more times until all data words of the response DOE data object have been sent to the host device 405. For example, at block 525, when the device 410 has no more remaining data words to transmit, the device 410 may stop transmission of the response DOE data object and may clear the DOE ready bit 520 (e.g., set the DOE ready bit 520 to a second value) to indicate completion of the transmission of the response DOE data object, as shown by block 565. After reading the final data word (at block 540) and reading the DOE ready bit 520 in the DOE status register 515 (at block 560), the host device 405 may identify that the DOE ready bit 520 in the DOE status register 515 has been cleared (e.g., is not set or is set to the second value) at block 555. Accordingly, as shown by block 570, the host device 405 (e.g., software executing on the host device 405) may stop reading data words from the DOE read mailbox register 535.

As indicated above, FIG. 5 is provided as an example. Other examples may differ from what is described with regard to FIG. 5.

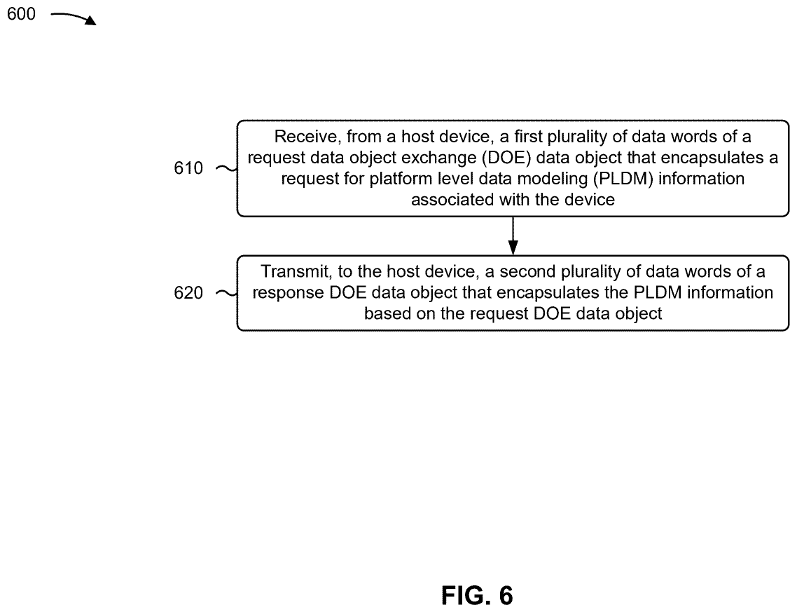

FIG. 6 is a flowchart of an example method 600 associated with PLDM over DOE. In some implementations, a device (e.g., the device 410) may perform or may be configured to perform the method 600. In some implementations, another device or a group of devices separate from or including the device (e.g., memory system 110, or CXL compliant memory system 204) may perform or may be configured to perform the method 600. Additionally, or alternatively, one or more components of the device (e.g., memory system controller 115 or a local controller 125) may perform or may be configured to perform the method 600. Thus, means for performing the method 600 may include the device and/or one or more components of the device. Additionally, or alternatively, a non-transitory computer-readable medium may store one or more instructions that, when executed by the device, cause the device to perform the method 600.

As shown in FIG. 6, the method 600 may include receiving, from a host device, a first plurality of data words of a request DOE data object that encapsulates a request for PLDM information associated with the device (block 610). As further shown in FIG. 6, the method 600 may include transmitting, to the host device, a second plurality of data words of a response DOE data object that encapsulates the PLDM information based on the request DOE data object (block 620).

The method 600 may include additional aspects, such as any single aspect or any combination of aspects described below and/or described in connection with one or more other methods or operations described elsewhere herein.

In a first aspect, the request DOE data object includes an indication of a first data object type associated with PLDM request and response messages.

In a second aspect, alone or in combination with the first aspect, the response DOE data object includes an indication of the first data object type.

In a third aspect, alone or in combination with one or more of the first and second aspects, the method 600 includes transmitting, to the host device, a third plurality of data words of an asynchronous DOE message including additional PLDM information, wherein the asynchronous DOE message includes an indication of a second data object type associated with asynchronous PLDM messages.

In a fourth aspect, alone or in combination with one or more of the first through third aspects, the first plurality of data words includes an indication of at least one of a message type associated with the request for PLDM information, a PLDM type associated with the PLDM information, or a PLDM command.

In a fifth aspect, alone or in combination with one or more of the first through fourth aspects, the second plurality of data words indicates at least one of a message type associated with the request for PLDM information, a PLDM type associated with the PLDM information, a PLDM command, or a PLDM completion code.

In a sixth aspect, alone or in combination with one or more of the first through fifth aspects, the request DOE data object includes an indication of a vendor identifier and a quantity of the first plurality of data words.

In a seventh aspect, alone or in combination with one or more of the first through sixth aspects, the response DOE data object includes an indication of a vendor identifier and a quantity of the second plurality of data words.

In an eighth aspect, alone or in combination with one or more of the first through seventh aspects, a payload of the request DOE data object comprises the first plurality of data words, and a payload of the response DOE data object comprises the second plurality of data words.

In a ninth aspect, alone or in combination with one or more of the first through eighth aspects, the method 600 includes reading the first plurality of data words from a PCIe DOE mailbox.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

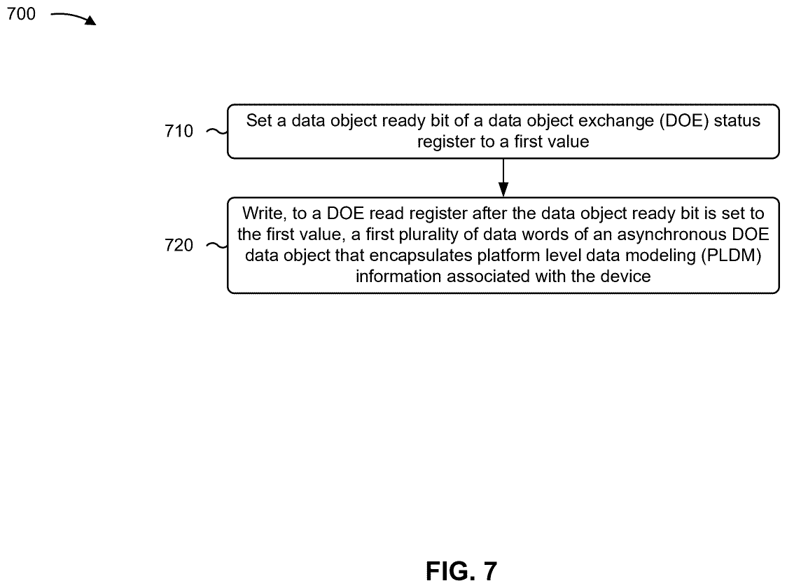

FIG. 7 is a flowchart of an example method 700 associated with PLDM over DOE. In some implementations, a device (e.g., the device 410) may perform or may be configured to perform the method 700. In some implementations, another device or a group of devices separate from or including the device (e.g., memory system 110, or CXL compliant memory system 204) may perform or may be configured to perform the method 600. Additionally, or alternatively, one or more components of the device (e.g., memory system controller 115 or a local controller 125) may perform or may be configured to perform the method 600. Thus, means for performing the method 700 may include the device and/or one or more components of the device. Additionally, or alternatively, a non-transitory computer-readable medium may store one or more instructions that, when executed by the device, cause the device to perform the method 700.

As shown in FIG. 7, the method 700 may include setting a data object ready bit of a DOE status register to a first value (block 710). As further shown in FIG. 7, the method 700 may include writing, to a DOE read register after the data object ready bit is set to the first value, a first plurality of data words of an asynchronous DOE data object that encapsulates PLDM information associated with the device (block 720).

The method 700 may include additional aspects, such as any single aspect or any combination of aspects described below and/or described in connection with one or more other methods or operations described elsewhere herein.

In a first aspect, the method 700 includes reading, from the DOE read register, one or more values indicating that a read operation associated with the asynchronous DOE data object was successful.

In a second aspect, alone or in combination with the first aspect, the method 700 includes writing a first data word of the first plurality of data words to the DOE read register, reading a first value of the one or more values, and writing a second data word of the first plurality of data words to the DOE read register in accordance with the first value.

In a third aspect, alone or in combination with one or more of the first and second aspects, the method 700 includes setting, after the first plurality of data words are written to the DOE read register, the data object ready bit to a second value to indicate a completion of the asynchronous DOE data object.

In a fourth aspect, alone or in combination with one or more of the first through third aspects, the method 700 includes reading, from the DOE read register, a second plurality of data words of a request DOE data object that encapsulates a request for PLDM information associated with the device, and writing, to the DOE read register, a third plurality of data words of a response DOE data object that encapsulates the PLDM information based at least in part on the request DOE data object.

In a fifth aspect, alone or in combination with one or more of the first through fourth aspects, the method 700 includes setting, after the second plurality of data words are read, the data object ready bit to the first value, and setting, after the third plurality of data words are written, the data object ready bit to a second value.

In a sixth aspect, alone or in combination with one or more of the first through fifth aspects, the second plurality of data words and the third plurality of data words each include a respective indication of a first DOE object type associated with synchronous PLDM messages, and wherein the first plurality of data words includes an indication of a second DOE object type associated with asynchronous PLDM messages.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

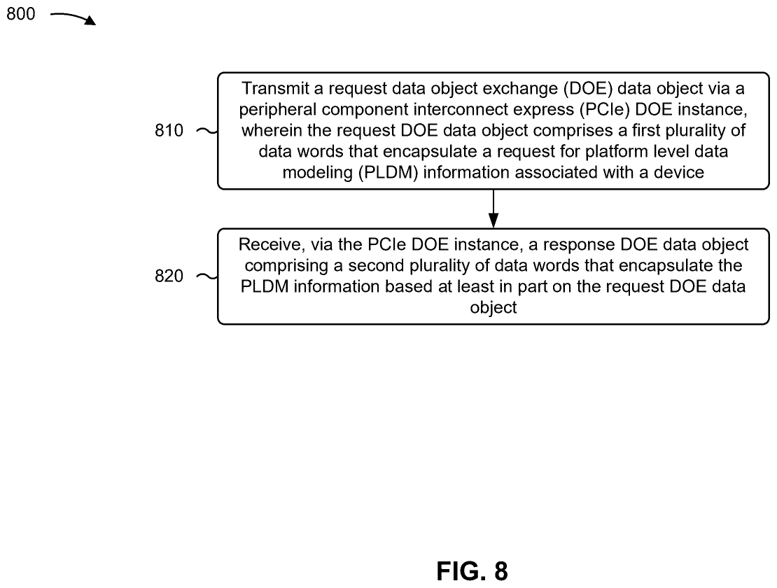

FIG. 8 is a flowchart of an example method 800 associated with PLDM over DOE. In some implementations, a host device (e.g., the host device 405) may perform or may be configured to perform the method 800. In some implementations, another device or a group of devices separate from or including the host device (e.g., host system 105 or CXL host 202) may perform or may be configured to perform the method 800. Additionally, or alternatively, one or more components of the host device (e.g., host processor 150) may perform or may be configured to perform the method 800. Thus, means for performing the method 800 may include the host device and/or one or more components of the host device. Additionally, or alternatively, a non-transitory computer-readable medium may store one or more instructions that, when executed by the host device, cause the host device to perform the method 800.

As shown in FIG. 8, the method 800 may include transmitting a request DOE data object via a PCIe DOE instance, wherein the request DOE data object comprises a first plurality of data words that encapsulate a request for PLDM information associated with a device (block 810). As further shown in FIG. 8, the method 800 may include receiving, via the PCIe DOE instance, a response DOE data object comprising a second plurality of data words that encapsulate the PLDM information based at least in part on the request DOE data object (block 820).

The method 800 may include additional aspects, such as any single aspect or any combination of aspects described below and/or described in connection with one or more other methods or operations described elsewhere herein.

In a first aspect, the method 800 includes receiving, via the PCIe DOE instance, an asynchronous DOE data object comprising a third plurality of data words that encapsulate additional PLDM information.

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein.

In some implementations, a device includes one or more components configured to: receive, from a host device, a first plurality of data words of a request DOE data object that encapsulates a request for PLDM information associated with the device; and transmit, to the host device, a second plurality of data words of a response DOE data object that encapsulates the PLDM information based on the request DOE data object.

In some implementations, a device includes one or more components configured to: set a data object ready bit of a DOE status register to a first value; and write, to a DOE read register after the data object ready bit is set to the first value, a first plurality of data words of an asynchronous DOE data object that encapsulates PLDM information associated with the device.

In some implementations, a system comprises: a host device comprising one or more first components configured to: transmit, over a DOE instance associated with PLDM messages, a first plurality of data words of a request DOE data object that encapsulates a request for PLDM information; and a device comprising one or more second components configured to: transmit, over the DOE instance, a second plurality of data words of a response DOE data object based at least in part on the request DOE data object, wherein the response DOE data object encapsulates the PLDM information.

In some implementations, a method includes transmitting a request DOE data object via a PCIe DOE instance, wherein the request DOE data object comprises a first plurality of data words that encapsulate a request for PLDM information associated with a device; and receiving, via the PCIe DOE instance, a response DOE data object comprising a second plurality of data words that encapsulate the PLDM information based at least in part on the request DOE data object.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device, comprising:
one or more components configured to:
receive, from a host device, a first plurality of data words of a request data object exchange (DOE) data object that encapsulates a request for platform level data modeling (PLDM) information associated with the device; and
transmit, to the host device, a second plurality of data words of a response DOE data object that encapsulates the PLDM information based on the request DOE data object.

2. The device of claim 1, wherein the request DOE data object includes an indication of a first data object type associated with PLDM request and response messages.

3. The device of claim 2, wherein the response DOE data object includes an indication of the first data object type.

4. The device of claim 2, wherein the one or more components are configured to:
transmit, to the host device, a third plurality of data words of an asynchronous DOE message including additional PLDM information,
wherein the asynchronous DOE message includes an indication of a second data object type associated with asynchronous PLDM messages.

5. The device of claim 1, wherein the first plurality of data words includes an indication of at least one of a message type associated with the request for PLDM information, a PLDM type associated with the PLDM information, or a PLDM command.

6. The device of claim 1, wherein the second plurality of data words indicates at least one of a message type associated with the request for PLDM information, a PLDM type associated with the PLDM information, a PLDM command, or a PLDM completion code.

7. The device of claim 1, wherein the request DOE data object includes an indication of a vendor identifier and a quantity of the first plurality of data words.

8. The device of claim 1, wherein the response DOE data object includes an indication of a vendor identifier and a quantity of the second plurality of data words.

9. The device of claim 1, wherein a payload of the request DOE data object comprises the first plurality of data words, and a payload of the response DOE data object comprises the second plurality of data words.

10. The device of claim 1, wherein, to receive the request DOE data object, the one or more components are configured to:
read the first plurality of data words from a peripheral component interconnect express (PCIe) DOE mailbox.

11. A device, comprising:
one or more components configured to:
set a data object ready bit of a data object exchange (DOE) status register to a first value; and
write, to a DOE read register after the data object ready bit is set to the first value, a first plurality of data words of an asynchronous DOE data object that encapsulates platform level data modeling (PLDM) information associated with the device.

12. The device of claim 11, wherein the one or more components are configured to:
read, from the DOE read register, one or more values indicating that a read operation associated with the asynchronous DOE data object was successful.

13. The device of claim 12, wherein, to write the first plurality of data words, the one or more components are configured to:
write a first data word of the first plurality of data words to the DOE read register;
read a first value of the one or more values; and
write a second data word of the first plurality of data words to the DOE read register in accordance with the first value.

14. The device of claim 11, wherein the one or more components are configured to:
set, after the first plurality of data words are written to the DOE read register, the data object ready bit to a second value to indicate a completion of the asynchronous DOE data object.

15. The device of claim 11, wherein the one or more components are configured to:
read, from the DOE read register, a second plurality of data words of a request DOE data object that encapsulates a request for PLDM information associated with the device; and
write, to the DOE read register, a third plurality of data words of a response DOE data object that encapsulates the PLDM information based at least in part on the request DOE data object.

16. The device of claim 15, wherein the one or more components are configured to:
set, after the second plurality of data words are read, the data object ready bit to the first value; and
set, after the third plurality of data words are written, the data object ready bit to a second value.

17. The device of claim 15, wherein the second plurality of data words and the third plurality of data words each include a respective indication of a first DOE object type associated with synchronous PLDM messages, and wherein the first plurality of data words includes an indication of a second DOE object type associated with asynchronous PLDM messages.

18. A system comprising:
a host device comprising one or more first components configured to:
transmit, over a data object exchange (DOE) instance associated with platform level data modeling (PLDM) messages, a first plurality of data words of a request DOE data object that encapsulates a request for PLDM information; and
a device comprising one or more second components configured to:
transmit, over the DOE instance, a second plurality of data words of a response DOE data object based at least in part on the request DOE data object, wherein the response DOE data object encapsulates the PLDM information.

19. The system of claim 18, wherein the one or more second components of the device are configured to:
transmit, over the DOE instance, a third plurality of data words of an asynchronous DOE message including additional PLDM information, wherein the asynchronous DOE message includes an indication of a first data object type associated with asynchronous PLDM messages.

20. The system of claim 19, wherein the request DOE data object includes an indication of a first data object type associated with synchronous PLDM messages, and wherein the response DOE data object includes an indication of the first data object type.

21. The system of claim 18, wherein the one or more first components are configured to:
set, after the first plurality of data words are written, a DOE go bit of a DOE control register to a first value to indicate a completion of the request DOE data object.

22. The system of claim 18, wherein the first plurality of data words includes an indication of at least one of a message type associated with the request for PLDM information, a PLDM type associated with the PLDM information, or a PLDM command.

23. The system of claim 18, wherein the second plurality of data words indicates at least one of a message type associated with the request for PLDM information, a PLDM type associated with the PLDM information, a PLDM command, or a PLDM completion code.

24. A method, comprising:
transmitting a request data object exchange (DOE) data object via a peripheral component interconnect express (PCIe) DOE instance,
wherein the request DOE data object comprises a first plurality of data words that encapsulate a request for platform level data modeling (PLDM) information associated with a device; and
receiving, via the PCIe DOE instance, a response DOE data object comprising a second plurality of data words that encapsulate the PLDM information based at least in part on the request DOE data object.

25. The method of claim 24, further comprising:
receiving, via the PCIe DOE instance, an asynchronous DOE data object comprising a third plurality of data words that encapsulate additional PLDM information.
